(19) United States
(12) Patent Application Publication
(10) Pub. No.: US 2013/0065604 A1
(43) Pub. Date: Mar. 14, 2013

(54) METHOD FOR SEAMLESS TRANSITION FROM URBAN OUTDOOR ENVIRONMENTS TO INDOOR NAVIGATION

(71) Applicants: Benjamin A. Werner, Santa Clara, CA (US); Sundar Raman, Santa Clara, CA (US); Lionel Jacques Garin, Palo Alto, CA (US)

(72) Inventors: Benjamin A. Werner, Santa Clara, CA (US); Sundar Raman, Santa Clara, CA (US); Lionel Jacques Garin, Palo Alto, CA (US)

(73) Assignee: QUALCOMM Incorporated, San Diego, CA (US)

(21) Appl. No.: 13/231,902

(22) Filed: Sep. 13, 2011

(51) Int. Cl. H04W 24/00

(52) U.S. Cl. 455/456.1

(57) ABSTRACT

Techniques are disclosed for managing operation of multiple estimators in a wireless device. In at least one implementation, techniques for providing relatively seamless transition between dissimilar regions of a state space may be provided.

### BACKGROUND

1. Field

Subject matter disclosed herein relates generally to positioning and, more particularly, to positioning across regions of a state space where measurement and motion models are dissimilar.

2. Information

A position estimator is generally most accurate within a subset of a full state space. This may be due to a number of different causes including, for example, the estimation technique being used, the measurements the estimator accepts, environmental conditions in different regions, and/or other factors. As a user traverses a state space, the user may often travel between regions of the state space that have different characteristics. Positioning techniques are needed for maintaining reliable and fluid positioning performance while transitioning between dissimilar regions.

### SUMMARY

In some implementations, a machine implemented method may be provided that includes: calculating probabilities of multiple position estimators associated with a mobile device; sampling beliefs of the multiple position estimators based, at least in part, on the probabilities to generate first samples; and updating a combined belief for the multiple positioning estimators based, at least in part, on the first samples. The method may be repeated in a loop during operation of the mobile device in certain implementations. Steps for activating and deactivating individual position estimators within the mobile device may also be optionally provided.

In some other implementations, an apparatus may be provided that includes: one or more sensors to obtain measurements; and a processor to: initialize a combined belief for active estimators of a plurality of position estimators based, at least in part, on said measurements; calculate probabilities of said active estimators; sample beliefs of said active estimators based, at least in part, on said probabilities to generate samples; and update said combined belief for said active estimators based, at least in part, on said first samples.

In some other implementations, an article may be provided that includes: a non-transitory storage medium comprising machine-readable instructions stored thereon which are executable by a special purpose computing apparatus to: calculate probabilities of multiple position estimators associated with a mobile device; sample beliefs of said multiple position estimators based, at least in part, on said probabilities to generate first samples; and update a combined belief for said multiple positioning estimators based, at least in part, on said first samples.

In some other implementations, an apparatus may be provided that includes: means for calculating probabilities of multiple position estimators associated with a mobile device; means for sampling beliefs of said multiple position estimators based, at least in part, on said probabilities to generate first samples; and means for updating a combined belief for said multiple positioning estimators based, at least in part, on said first samples.

In some other implementations, a method comprises, at a mobile device: defining multiple operating regions of said mobile device, said mobile device being capable of acquiring satellite positioning system (SPS) signals in at least a first region, acquiring indoor navigation signals in at least a second region; applying a first estimator to process acquired SPS signals while operating in said first region and applying a second estimator to process acquired indoor navigation signals while operating in said second region; and combining results from said first and second estimators for estimating or predicting a navigation state of said mobile device while said mobile device is in a region overlapping said first and second regions.

In some other implementations, an apparatus comprises: a receiver to acquire SPS signals and indoor navigation signals; and a processor to: define multiple operating regions of a mobile device including a first region where said mobile device is capable of acquiring satellite positioning system (SPS) and a second region where said mobile device is capable of acquiring indoor navigation signals; apply a first estimator to process said acquired SPS signals while said mobile device is operating in said first region and apply a second estimator to process said acquired indoor navigation signals while said mobile device is operating in said second region; and combine results from said first and second estimators for estimating or predicting a navigation state of said mobile device while said mobile device is in a region overlapping said first and second regions.

In other implementations, an article comprises: a non-transitory storage medium comprising machine-readable instructions stored thereon which are executable by a special purpose computing apparatus to: define multiple operating regions of a mobile device including a first region where said mobile device is capable of acquiring SPS and a second region where said mobile device is capable of acquiring indoor navigation signals; apply a first estimator to process said acquired SPS signals while said mobile device is operating in said first region and apply a second estimator to process said acquired indoor navigation signals while said mobile device is operating in said second region; and combine results from said first and second estimators for estimating or predicting a navigation state of said mobile device while said mobile device is in a region overlapping said first and second regions.

In other implementations, an apparatus comprises: means for defining multiple operating regions of said mobile device, said mobile device being capable of acquiring SPS signals in at least a first region, acquiring indoor navigation signals in at least a second region; means for applying a first estimator to process acquired SPS signals while operating in said first region and applying a second estimator to process acquired indoor navigation signals while operating in said second region; and means for combining results from said first and second estimators for estimating or predicting a navigation state of said mobile device while said mobile device is in a region overlapping said first and second regions.

### BRIEF DESCRIPTION OF THE FIGURES

Non-limiting and non-exhaustive implementations will be described with reference to the following figures, wherein like reference numerals refer to like parts throughout the various figures unless otherwise specified.

FIG. 1 is a schematic diagram illustrating an implementation of an example computing environment that may include one or more networks or devices capable of partially or substantially implementing or supporting one or more processes for managing operation of a number of position estimators;

FIG. 2 is a block diagram illustrating an example mobile device having positioning functionality in accordance with an implementation;

FIGS. 3 and 4 are portions of a flowchart illustrating an example method for managing a number of estimators within a mobile device in accordance with an implementation;

FIG. 5 is a flowchart illustrating another example method for managing a number of estimators within a mobile device in accordance with an implementation;

FIG. 6 is a plan view of an example movement scenario for a mobile device user that illustrates operation of a seamless positioning transition technique in accordance with an implementation; and

FIG. 7 is a flowchart illustrating still another example method for managing a number of estimators associated with a mobile device in accordance with an implementation.

### DETAILED DESCRIPTION

Reference throughout this specification to “one implementation,” “an implementation,” “certain implementations,” or “various implementations” means that a particular feature, structure, or characteristic described in connection with a described implementation may be included in at least one implementation of claimed subject matter. Thus, appearances of the phrase “in one example implementation,” “in an example implementation,” “in certain example implementations,” or “in various example implementations” in various places throughout this specification are not necessarily all referring to the same implementation(s). Furthermore, particular features, structures, or characteristics may be combined in one or more implementations.

Positioning systems often rely on estimation techniques that use known measurements to derive unknown quantities (e.g., position of a user, etc.). A set of possible values that the unknown quantities may assume may be referred to as the “state space.” Some positioning techniques may be based on probabilistic models, meaning that a set of possible values are considered that have comparable likelihoods in a state space. Using probabilistic models, a likelihood function may be maintained by an estimator over all position values. In some probabilistic based estimators, this likelihood function may also consist of one or more other parameters that may define a probability distribution over position. This probability distribution over position and possibly other parameters may be referred to as the “belief” of an estimator.

In many cases, an estimator may be most accurate in only a subset of a full state space. In other portions of the state space, for example, the estimator may be more error prone or even unusable. This can arise from, for example, the particular measurements that the estimator accepts, the estimation technique that the estimator uses, the environmental characteristics of different regions of the state space, and/or other reasons. In a mobile computing context, a mobile device may be carried by a user through different regions having very different characteristics. For example, during a typical job commute, a user may leave her suburban home in an automobile, travel along a highway toward a city center, park her vehicle in a parking garage, leave the parking garage on foot, walk a few blocks to a large office building, and then enter the building and proceed to her office to start the work day. As can be appreciated, this user has traversed many different regions having different environmental characteristics. A single position estimator may not be optimal to cover all of these different regions. If multiple different estimators are used, however, there may be discontinuities while transitioning between regions that create positioning inaccuracies. In some implementations discussed herein, positioning techniques may be presented that are capable of providing relatively smooth transitions between different regions for a mobile user. Some techniques discussed herein describe how to manage a set of estimators in such a way as to produce position estimates based on the accuracy of the individual estimators. This may be accomplished by, for example, combining outputs of different estimators based on which estimators produce belief and measurement models that best explain available measurements.

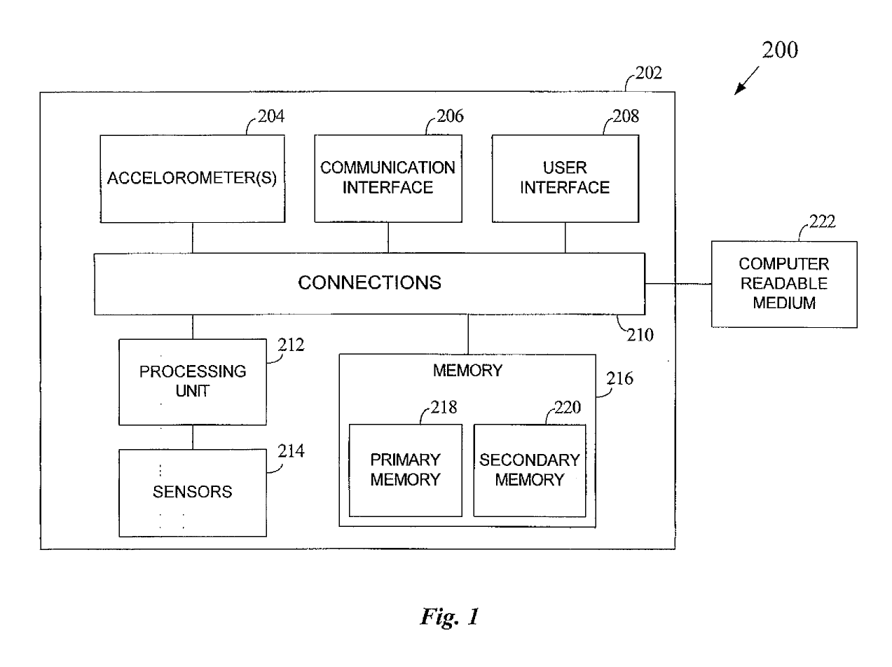

FIG. 1 is a schematic diagram illustrating an implementation of an example computing environment 200 that may include one or more networks or devices capable of partially or substantially implementing or supporting one or more processes for managing operation of a number of estimators to estimate a position. It should be appreciated that all or part of various devices or networks shown in computing environment 200, processes, or methods, as described herein, may be implemented using various hardware, firmware, or any combination thereof along with software. Computing environment 200 may include, for example, a mobile device 202, which may be communicatively coupled to any number of other devices, mobile or otherwise, via a suitable communications network, such as a cellular telephone network, the Internet, mobile ad-hoc network, wireless sensor network, or the like. In an implementation, mobile device 202 may be representative of any electronic device, appliance, or machine that may be capable of exchanging information over any suitable communications network. For example, mobile device 202 may include one or more computing devices or platforms associated with, for example, cellular telephones, satellite telephones, smart telephones, personal digital assistants (PDAs), laptop computers, personal entertainment systems, e-book readers, tablet personal computers (PC), personal audio or video devices, personal navigation devices, or the like. In certain example implementations, mobile device 202 may take the form of one or more integrated circuits, circuit boards, or the like that may be operatively enabled for use in another device. Although not shown, optionally or alternatively, there may be additional devices, mobile or otherwise, communicatively coupled to mobile device 202 to facilitate or otherwise support one or more processes associated with computing environment 200. Thus, unless stated otherwise, to simplify discussion, various functionalities, elements, components, etc. are described below with reference to mobile device 202 may also be applicable to other devices not shown so as to support one or more processes associated with example computing environment 200.

Computing environment 200 may include, for example, various computing or communication resources capable of providing position or location information with regard to a mobile device 202 based, at least in part, on one or more wireless signals associated with a positioning system, location-based service, or the like. Although not shown, in certain example implementations, mobile device 202 may include, for example, a location-aware or tracking unit capable of acquiring or providing all or part of orientation, position information (e.g., via trilateration, heat map signature matching, etc.), etc. Such information may be provided in support of one or more processes in response to user instructions, motion-controlled or otherwise, which may be stored in memory 216, for example, along with other suitable or desired information, such as one or more threshold values, or the like.

Memory 216 may represent any suitable or desired information storage medium. For example, memory 216 may include a primary memory 218 and a secondary memory 220. The primary memory 218 may include, for example, a random access memory, read only memory, etc. While illustrated in this example as being separate from a processing unit 212, it should be appreciated that all or part of primary memory 218 may be provided within or otherwise co-located/coupled with processing unit 212. Secondary memory 220 may include, for example, the same or similar type of memory as primary memory 218 or one or more information storage devices or systems, such as, for example, a disk drive, an optical disc drive, a tape drive, a solid state memory drive, etc. In certain implementations, secondary memory 220 may be operatively receptive of, or otherwise enabled to be coupled to, a computer-readable medium 222.

Computer-readable medium 222 may include, for example, any medium that can store or provide access to information, code or instructions (e.g., an article of manufacture, etc.) for one or more devices associated with computing environment 200. For example, computer-readable medium 222 may be provided or accessed by processing unit 212. As such, in certain example implementations, the methods or apparatuses may take the form, in whole or part, of a computer-readable medium that may include computer-implementable instructions stored thereon, which, if executed by at least one processing unit or other like circuitry, may enable processing unit 212 or the other like circuitry to perform all or portions of location determination processes, sensor-based or sensor-supported measurements (e.g., acceleration, deceleration, orientation, tilt, rotation, etc.) or any like processes. In certain example implementations, processing unit 212 may be capable of performing or supporting other functions, such as communications, gaming, or the like.

Processing unit 212 may be implemented in hardware or a combination of hardware and software. Processing unit 212 may be representative of one or more circuits capable of performing at least a portion of information computing technique or process. By way of example but not limitation, processing unit 212 may include one or more processors, controllers, microprocessors, microcontrollers, application specific integrated circuits, digital signal processors, programmable logic devices, field programmable gate arrays, or the like, or any combination thereof.

Mobile device 202 may include various components or circuitry, such as, for example, one or more accelerometers 204, or various other sensor(s) 214, such as a magnetic compass, a gyroscope, a video sensor, a gravitometer, etc. to facilitate or otherwise support one or more processes associated with computing environment 200. For example, such sensors may provide analog or digital signals to processing unit 212. Although not shown, it should be noted that mobile device 202 may include an analog-to-digital converter (ADC) for digitizing analog signals from one or more sensors. Optionally or alternatively, such sensors may include a designated (e.g., an internal, etc.) ADC(s) to digitize respective output signals, although claimed subject matter is not so limited.

Although not shown, mobile device 202 may also include a memory or information buffer to collect suitable or desired information, such as, for example, accelerometer measurement information, as previously mentioned. Mobile device 202 may also include a power source, for example, to provide power to some or all of the components or circuitry of mobile device 202. A power source may be a portable power source, such as a battery, for example, or may comprise a fixed power source, such as an outlet (e.g. in a house, electric charging station, car, etc.). It should be appreciated that a power source may be integrated into (e.g., built-in, etc.) or otherwise supported by (e.g., stand-alone, etc.) mobile device 202.

Mobile device 202 may include one or more connections 210 (e.g., buses, lines, conductors, optic fibers, etc.) to operatively couple various circuits together, and a user interface 208 (e.g., display, touch screen, keypad, buttons, knobs, microphone, speaker, trackball, data port, etc.) to receive user input, facilitate or support sensor-related signal measurements, or provide information to a user. Mobile device 202 may further include a communication interface 206 (e.g., wireless transmitter or receiver, modem, antenna, SPS receiver, etc.) to allow for communication with one or more other devices or systems over one or more suitable communications networks or links, as was indicated. In one particular implementation, mobile device 202 may comprise a receiver to acquire multiple types of signals such as SPS signals and indoor navigation signals.

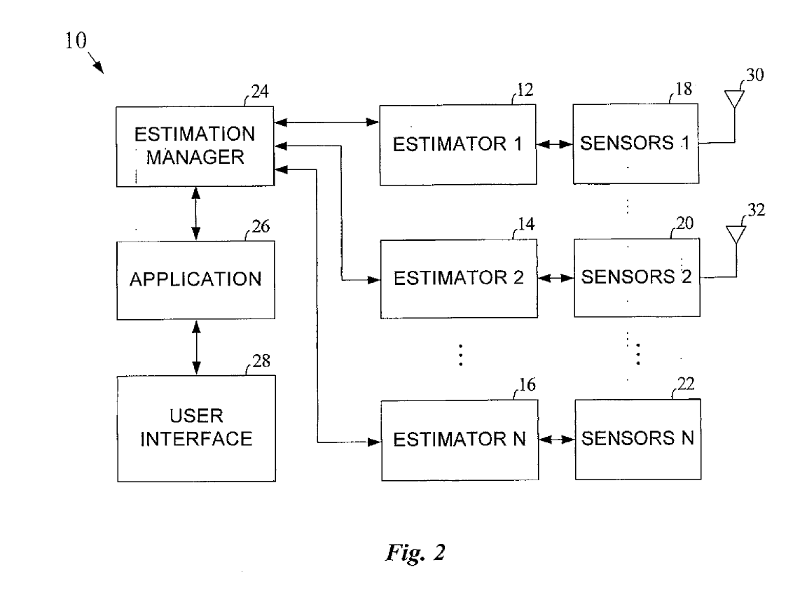

FIG. 2 is a block diagram illustrating an example mobile device 10 having positioning functionality in accordance with an implementation. Mobile device 10 may be an implementation of for example, mobile device 202 of FIG. 1 or a similar device. As shown, mobile device 10 may include a number of estimators 12, 14, 16 having corresponding sensors 18, 20, 22; an estimation manager 24; at least one location-based application 26; and a user interface 28. Estimators 12, 14, 16 may include different types of estimators that are each capable of estimating a user position and possibly one or more other parameters of a state space defining a navigation state, for example. Although depicted with three estimators 12, 14, 16 in FIG. 1, it should be appreciated that two or more estimators may be used in any particular implementation. Sensors 18, 20, 22 may include components, devices, and/or instruments that are operative for collecting measurements that are used by estimators 12, 14, 16 to perform estimation. Some of sensors 18, 20, 22 may include wireless capabilities for deriving measurement information wirelessly from remote sources. For example, sensors 18 may include, for example, a wireless networking transceiver (e.g., an IEEE 802.11 transceiver capable of acquiring indoor navigation signals transmitted from a wireless local area network, etc.) for obtaining navigation or position related information from one or more wireless access points or base stations. Similarly, sensors 20 may include, for example, one or more receiver channels for receiving satellite positioning system (SPS) signals from navigation satellites. As illustrated, one or more antennas 30, 32 and/or other transducers may be coupled to one or more of sensors 18, 20 to facilitate wireless communication with remote entities. Sensors 18, 20, 22 may also, or alternatively, include one or more components or devices that collect measurements without acquiring wireless signals (e.g., inertial sensors such as accelerometers, etc.).

Each of estimators 12, 14, 16 may use one or a number of different sensors to collect measurements (e.g., sensors 18 may include one or multiple different sensors). In addition, each of estimators 12, 14, 16 may use different sensors 18, 20, 22 than the other estimators 12, 14, 16, although some sensors may be shared by two or more estimators.

Location-based application(s) 26 may include any application that relies on a position estimate for mobile device 10. Such applications may include, for example, pedestrian navigation, point-of-interest identification, vehicle or personnel tracking, location for emergency services dispatching, travel routing services (e.g., finding a travel route having the lowest traffic congestion, etc.), and/or many others. The location-based application(s) 26 may be executed within, for example, one or more digital processing devices of the mobile device 10 (e.g., processing unit 212 of FIG. 1). User interface 28 may include functionality for allowing inputs from and outputs to a user of mobile device 10. User interface 28 may include, for example, a display or touch screen, a keyboard, a stylus, buttons, one or more microphones and/or speakers, a camera or other imaging device, and/or others, including control functionality used to control such structures. Location-based application(s) 26 may, for example, utilize user interface 28 for communicating real time location-based information to a user.

Some of estimators 12, 14, 16 may be more accurate in some types of environments than other types. For example, one of estimators 12, 14, 16 may include a particle filter type estimator that may perform best in an indoor environment applied to processing measurements of characteristics of indoor navigation signals acquired from a wireless network (e.g., IEEE 802.11 (WiFi) and the like) having known access point or base station locations; maps of the enclosed areas including locations of building entrances/exits; and/or inertial sensor measurements. Another of estimators 12, 14, 16 may use a Kalman filter-based approach for street level estimation in a city center that may utilize, for example, signals received from navigation satellites in a satellite positioning system (SPS) such as the Global Positioning System (GPS). Other or alternative types of estimators may also be used in various implementations.

As will be appreciated, as a user travels within a state space, he or she may traverse across and between different types of regions. Because different estimators may perform differently in different regions, positioning problems may arise in transitions between regions. In one possible approach, a mobile device may simply change the estimator that is being used if the mobile device enters a new type of region. However, this technique can result in major discontinuities in a positioning result at the transition point. In some cases, these discontinuities can result in positioning errors that may take an extended period of time for recovery. For example, if a user is transitioning between an outdoor environment and an indoor environment, a position error of an outdoor estimator may identify an incorrect doorway as an entry into the indoor environment to the indoor estimator. The indoor estimator then has to take time to recover from this initial error, during which time a user may be misdirected inside the building.

As will be discussed in greater detail, estimation manager 24 of FIG. 2 may be operative for managing transitions between dissimilar regions of a state space in a manner that is capable of providing more seamless and fluid transitions. Estimation manager 24 may, in some implementations, maintain a combined belief derived from the outputs of the individual estimators 12, 14, 16. This combined belief, or information derived from this combined belief, may be made available to location-based application(s) 26. In at least one approach, estimation manager 24 may maintain the combined belief in the form of particles that are drawn or sampled from estimators 12, 14, 16 according to their corresponding likelihoods. Other formats for the combined belief may alternatively be used. Estimation manager 24 may use the combined belief to, for example, check for estimators that are becoming relevant, initialize new relevant estimators, and/or provide combined estimation results.

Estimators 12, 14, 16, sensors 18, 20, 22, and estimation manager 24 may be implemented in hardware, software, firmware, or a combination thereof in various implementations. In some implementations, some or all of these elements may be realized in one or more digital processing devices such as, for example, a general purpose microprocessor, a digital signal processor (DSP), a reduced instruction set computer (RISC), a field programmable gate array, an application specific integrated circuit (ASIC), a microcontroller, and/or other processing devices, including combinations thereof. In the example architecture of FIG. 2, estimators 12, 14, 16, sensors 18, 20, 22, and estimation manager 24 are shown as being resident within a mobile device. In some implementations, however, some or all of these elements may be located outside a wireless device, such as at a network server or the like. In various implementations, cloud computing techniques and services may be utilized or provided as part of a positioning solution.

In various implementations, a number of assumptions may be made about the individual estimators 12, 14, 16 to support operation of estimation manager 24. It may be assumed, for example, that estimators 12, 14, 16 share a state space with one another that at least includes position. In some implementations, the shared state space may also include other useful parameters (e.g., velocity, etc.). It may also be assumed, for example, that an estimator can be initialized, accepting a set of values in the shared state space from an outside source as a representation of initial belief. If an input is particles, for example, an estimator may take this input and parameterize the distribution in order to create its own belief. A least squares or Kalman filtering technique may, for example, find a mean and covariance of incoming particles in order to parameterize the distribution. A particle filtering technique may, for example, re-sample incoming particles to another desired number and augment the particles with more states.

It may also be assumed in some implementations that an estimator can provide a Boolean response as to whether a value in the shared state space is within a particular subset of the state space where the estimator would yield a high likelihood for the expected measurements. This functionality does not have to be computationally intensive and may be used to determine, for example, whether an estimator should be activated or deactivated (assuming that the estimator is capable of deactivation). Although it is not necessary to include this functionality, the computation of likelihoods of measurements for all estimators may be computationally intensive, and this functionality can serve as a way to limit unnecessary activation of an estimator if it would not yield a high likelihood given the available measurements. By deactivating an estimator, its memory, computational resources, and power consumption may be freed for other uses.

It may further be assumed in some implementations that an estimator is capable of propagating its belief forward in time. This capability may be used, for example, to account for elapsed time between measurements. In one possible approach, this capability may use a dynamics model specific to the corresponding estimation method. For a Kalman filter-based estimator, for example, this capability may involve propagating a mean and covariance. For a particle filter-based estimator, this capability may involve drawing from a proposal distribution and re-sampling if necessary. Other types of estimator may use other techniques for propagating a belief forward in time.

In some implementations, it may be assumed that an estimator is capable of accepting measurements and incorporating them into its belief. This capability may be used for updating the individual estimators with newly available measurements from the environment. For a Kalman filter-based estimator, this may involve, for example, updating a mean and covariance with the observation and measurement noise matrices. For a particle filter based estimator, this may involve, for example, updating importance weights.

It may also be assumed in some implementations that an estimator is capable of providing a likelihood of a measurement given a current belief and measurement models. This capability may allow estimation manager 24 to compute the likelihood of the particular estimator after new measurements have been incorporated. The likelihood may be based on a measurement model and belief that is realistic for the particular estimator's ability. For a Kalman filter-based estimator, the measurement likelihood may be calculated, for example, by evaluating a normal PDF using the (a) difference between the expected measurement given the mean belief and the actual measurement, and (b) the expected measurement variance. For a particle filter-based estimator, the measurement likelihood may be calculated, for example, using the weighted sum of the measurement likelihood at each particle. Other techniques for calculating measurement likelihood may alternatively be used for these and other types of estimators.

Typically, if one estimator is being used, Bayes' rule may be used for a measurement model. This may be the case for estimators that use weighted least squares, a Kalman filter, a particle filter, as well as other techniques. Bayes' Rule may be expressed as follows:

$$p ( x \vert y ) = \frac{p ( y \vert x ) p ( x )}{p ( y )}$$

where y is an available measurement, x is the hidden state, p(y|x) is the measurement model, p(x) is the prior belief, and p(y) is the measurement likelihood. In the case where there are several estimators, the individual beliefs of the estimators may provide valuable information about the quantities being estimated. Before applying Bayes' rule to the multiple estimator case, a new discrete parameter (i.e., eᵣ) may be introduced to represent the estimators. Variable eᵣ can take on values of eᵣ={E₁, E₂ . . . E_{R}} representing each of the individual active estimators. Distribution p(xₖ|eᵣ,yₖ) is the belief of estimator eᵣ given the measurements yₖ and is treated as a probability over the state space conditioned on the estimator eᵣ. In order to combine beliefs of all active estimators, it may be useful to consider how likely each estimator is given the measurements, which is expressed in the distribution p(eᵣ|yₖ).

Given these two probabilistic quantities, a distribution that is representative of the knowledge of available active estimators can be made by marginalizing out the estimator variable eᵣ. Because eᵣ is discrete, this may be done by summing over possible eᵣ values as follows:

$$p ( {x}_{k} \vert {y}_{k} ) = {\sum }_{∀ {e}_{r}}^{ } p ( {x}_{k} \vert {e}_{r} , {y}_{k} ) p ( {e}_{r} \vert {y}_{k} )$$

The beliefs of the individual estimators may be tracked by the estimators themselves. However, the probability of an estimator may be calculated as well. The probability p(eᵣ|yₖ) may comprise a categorical distribution where each estimator has a specific probability given the measurements, cumulatively adding to one (or approximately one). Applying Bayes' rule, it can be seen that the probability of an estimator can be tracked as measurements are received as follows:

$$p ( {e}_{r} \vert {y}_{k} ) = \frac{p ( {y}_{k} \vert {e}_{r} ) p ( {e}_{r} )}{{\sum }_{∀ {e}_{r}}^{ } p ( {y}_{k} \vert {e}_{r} ) p ( {e}_{r} )} .$$

Distribution p(eᵣ) is the belief given previous measurements of the estimator's probability. Probability p(yₖ|eᵣ) is the likelihood of the measurements yₖ given that a particular estimator eᵣ is being used. In general, this may be computed using the estimator's measurement model p(yₖ|xₖ, eᵣ) and its belief p(xₖ) using the following expression:

p(yₖ|eᵣ)=∫p(yₖ|xₖ, eᵣ)p(xₖ)dxₖ.

In practice, this quantity may be simple to derive for most estimators. For a particle filter based estimator, for example, this quantity may be calculated by a weighted summing of the likelihood of the measurement over all particles. For a Kalman filter based estimator, this quantity may be calculated by, for example, evaluating the Normal PDF at the deviation from the measurement's expected value divided by the root of the expected variance on the measurement. Alternative calculation techniques may be used for these and other estimator types.

Because it may be difficult to parameterize a belief over all estimators, the distribution may be sampled and statistics about the belief can be derived from those samples. Sampling from the combined belief can be accomplished, for example, by first choosing an estimator according to the categorical distribution over eᵣ. Once an estimator has been selected, the selected estimator can provide a sample from its own belief. For a Kalman filter based estimator, this may be a sample from the multivariate normal distribution with the appropriate mean and covariance. For a particle filter based estimator, this may be a particle sampled using the categorical distribution formed by the particle weights of the proposal distribution. Other techniques may be used for other estimator types.

As described previously, in order to limit computational, storage, and power consumption burden within a wireless device, one or more of the available estimators may be deactivated during operation in some implementations. If an estimator's probability p(eᵣ) drops below a threshold value, for example, that estimator is unlikely to be chosen while sampling from the categorical belief over the estimators. Therefore, that estimator may not contribute in a significant manner to the combined belief and may be deactivated. A technique for activating inactive estimators may also be provided in some implementations. For most estimators, there may be a non-zero cost involved in activation and computing measurement likelihoods. Therefore, in some implementations, an estimator may first determine whether a value is within a portion of the state space where the estimator may produce a large likelihood. For positioning, this may be a region where the estimator is expected to be used. An estimator may then be activated while there is sufficient probability that the estimator's valid state space region has been entered.

The intersection of the valid state space of an estimator with the combined belief by at least the fraction p_{B} can be checked to an arbitrary probability of detection p_{D}. The combined belief may be sampled as described previously, with samples S={s₁, s₂, . . . s_{N}} available. In some implementations, every estimator may provide a Boolean response R={r₁, r₂ . . . r_{N}} that describes whether a sample is within a corresponding valid state space. R values can be considered a draw from a Bernoulli distribution. One technique for checking for the intersection is to evaluate M values in R and declare a sufficient intersection when one or more of the values is true. Using this strategy, the following formula may be used to describe the relationship between the probability of detection p_{D}, the intersection probability p_{B}, and the number of evaluated elements in R (i.e., M):

p_{D}=1−(1−p_{B})^{M}.

If sufficient intersection has been detected, a corresponding estimator may be activated and initialized with combined belief samples. In some implementations, a sufficient number of samples may be calculated as follows:

M=log₁₋ₚ_{_{B}}(1−p_{D}).

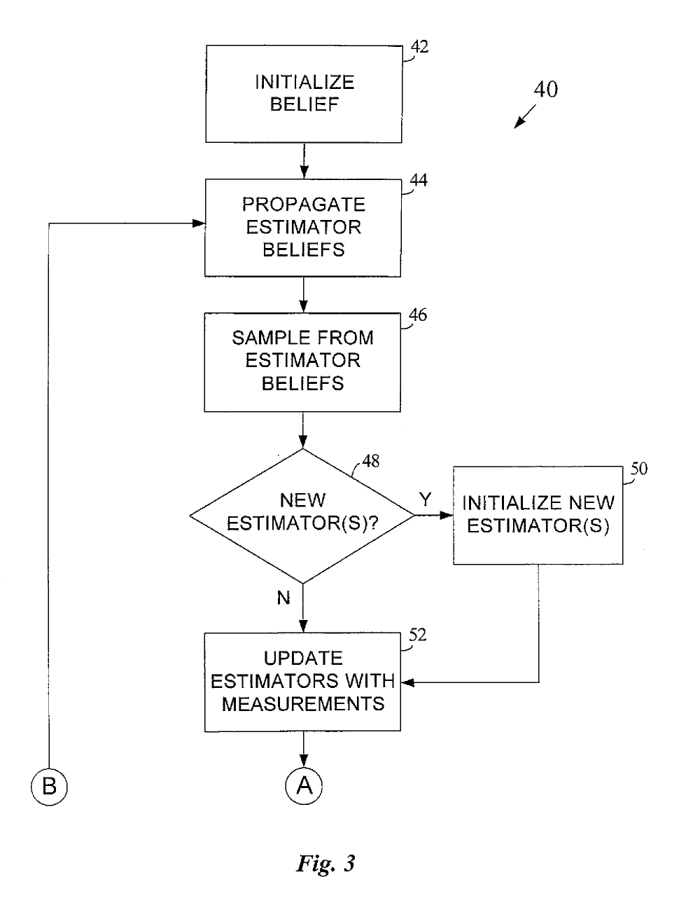

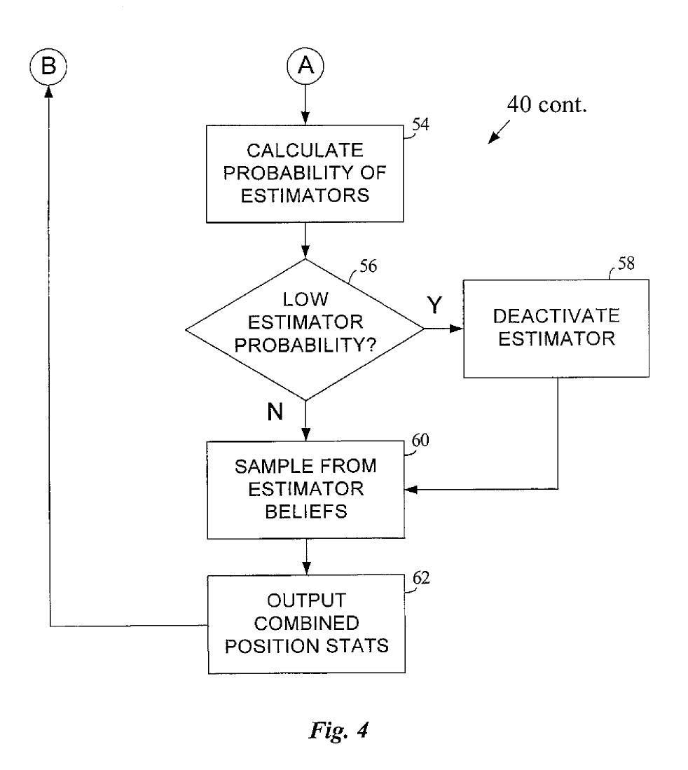

FIGS. 3 and 4 are portions of a flowchart illustrating an example method 40 for managing a number of estimators associated with a mobile device in accordance with an implementation. Method 40 may be implemented within, for example, mobile device 10 of FIG. 2 (e.g., by estimation manager 24 acting in conjunction with estimators 12, 14, 16, etc.), in other mobile devices, within an external server that is communicating with a mobile device, or at a combination of different locations. With reference to FIG. 3, a combined belief may first be initialized (block 42). In some implementations, the initialization of a combined belief may occur if and when, for example, an estimation manager function is first activated during a user session. A non-null set of initial estimators may be designated for use in initializing the combined belief using available measurements in some implementations. This set of estimators may include, for example, a single estimator or a set of multiple estimators from a previous user session. After the combined belief has been initialized, a loop may be entered that updates and maintains the combined belief based, at least in part, on sampling of the individual estimator beliefs. The beliefs of the individual estimators may change over time based on newly received measurements while a mobile device is in motion. In some implementations, as will be described in greater detail, individual estimators may be activated and deactivated during the loop processing based on, for example, estimator probability.

The beliefs of the individual estimators of the mobile device that are currently active may first be propagated forward in time to compensate for elapsed times between measurements (block 44). In the mobile device 10 of FIG. 1, the propagation forward in time may be performed by, for example, estimation manager 24 or by the individual estimators 12, 14, 16 under the direction of estimation manager 24. The estimator beliefs may then be sampled to determine whether one or more inactive estimators should be activated (block 46). In some implementations, it may be determined that an inactive estimator should be activated if a determination is made that the inactive estimator may improve the combined estimate. This can be determined by, for example, checking an intersection of the particles of a current belief with the inactive estimator's region of validity. If sufficient intersection is found between the current belief and the estimator's region of validity, a determination to activate the estimator may be made.

If it is determined that one or more estimators are to be activated (block 48-Y), the new estimator(s) may be initialized based on, for example, a current belief (block 50). After any new estimators have been initialized (block 50), or if it is determined that no new estimators are to be activated (block 48-N), the beliefs of each of the active estimators may be updated using the most recently acquired measurements (block 52). Techniques for updating estimators using measurement information are known in the art.

Referring now to FIG. 4, the probability of the active estimators may next be calculated (block 54). Example techniques for use in calculating the probability of an estimator have been described hereinbefore. In one approach, for example, the probabilities of the position estimators may be calculated as probabilities that individual estimator's beliefs and measurement models corroborate observed measurements. It may next be determined whether any of the calculated probabilities are below a specific threshold (block 56). If the calculated probability of an estimator is below the threshold, it may be assumed that the estimator may not contribute significantly to the accuracy of the combined distribution. Therefore, the corresponding estimator may be deactivated to free up computational, memory, and power resources for other uses (blocks 56-Y, 58). After any low probability estimators have been deactivated (block 58), or if it is determined that no estimators are to be deactivated (block 56-N), the beliefs of the active estimators may again be sampled for use in updating the combined belief (block 60). Here, in a particular implementation, application of multiple estimators may continue. Application of any particular estimator may then be discontinued responsive to changes in its confidence indicator (e.g., computed likelihood that the estimator is providing a reliable or accurate solution). In some implementations, this sampling may be performed based, at least in part, on the calculated probabilities of the active estimators, as described previously. The combined position statistics may then be generated and the combined belief may be updated based thereon (block 62). The method 40 may then return to block 44 where the beliefs of the active estimators are again propagated forward in time and the above-described processing may be repeated.

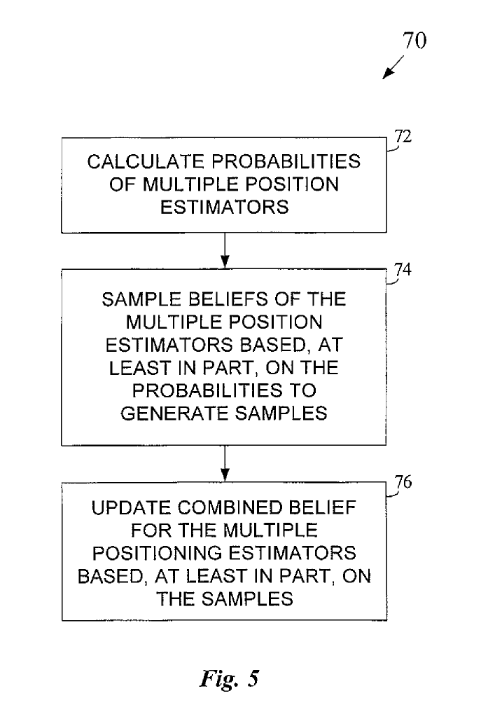

FIG. 5 is a flowchart illustrating an example method 70 for managing a number of estimators associated with a mobile device in accordance with an implementation. In this context, in a particular implementation, a probability of an estimator may represent a confidence for the estimator (e.g., a computed likelihood that the estimator is providing a reliable or accurate solution). Method 70 may be implemented within, for example, mobile device 10 of FIG. 2 (e.g., by estimation manager 24 acting in conjunction with estimators 12, 14, 16, etc.), in other mobile devices, within an external server that is communicating with a mobile device, or at a combination of different locations associated with a mobile device. Referring to FIG. 5, probabilities may first be calculated for each of multiple position estimators (block 72). In one approach, for example, the probabilities of the position estimators may be calculated as probabilities that individual estimator's beliefs and measurement models corroborate observed measurements. The probabilities may be calculated, for example, in a manner described previously for p(eᵣ|yₖ) or in a similar fashion. Beliefs of the multiple position estimators may then be sampled based, at least in part, on the calculated probabilities (block 74). Example techniques for performing this sampling have been described previously herein. A combined belief may next be updated based, at least in part, on the samples generated above (block 76).

In at least one implementation, the method 70 may be repeated continually during operation of a mobile device to appropriately maintain a combined belief. The method 70 may also be augmented to include mechanisms for activating one or more inactive estimators within the mobile device and/or deactivating one or more active estimators within the mobile device. Some example techniques for managing activation and deactivation of estimators were described previously. In at least one implementation, beliefs of each of the multiple position estimators may be propagated forward in time to compensate for differences in the timing of measurements for the different estimators before probabilities are calculated for the estimators. Mechanisms for updating estimators with new measurements may also be provided.

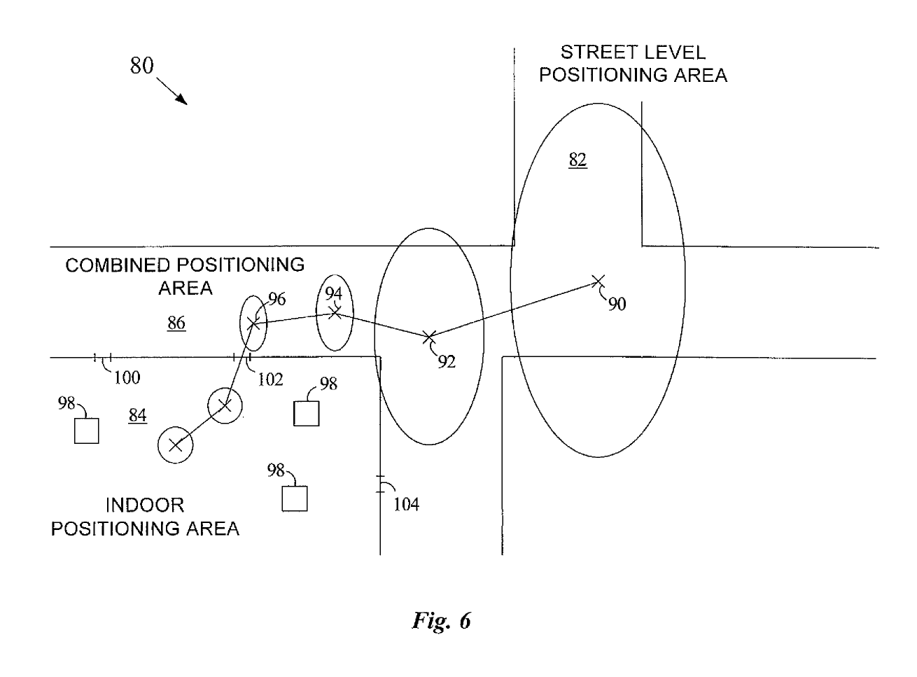

FIG. 6 is a plan view illustrating an example movement scenario 80 for a mobile device depicting operation of a seamless positioning technique in multiple operating regions in accordance with an implementation. In this scenario 80, a first estimator may use a Kalman filter to process acquired SPS signals in an operating region comprising a street-level positioning area 82. Similarly, a second estimator may use a particle filter to process acquired indoor navigation signals (received from, e.g., various wireless access points 98 or the like) in and around another operating region comprising an indoor-positioning area 84. In an intermediate region 86 between street-level positioning area 82 and indoor-positioning area 84 (e.g., in an overlapping operating region where a mobile device is capable of acquiring SPS signals and indoor navigation signals), a probabilistic combination of the first and second estimators may be used. During mobile device operation, a user at a location 90 within street-level positioning area 82 may start to walk toward an office building having indoor-positioning area 84. At first, only the first estimator may be active because of the distance between the mobile device and the indoor-positioning area 84. As the user approaches the office building, however, the second estimator may be activated by, for example, an estimation manager within the mobile device. A probabilistic combination of the outputs of the first and second estimators may then be used (e.g., at positions 92, 94, 96, etc.) to develop a positioning result.

If a user eventually enters indoor positioning area 84 of the office building through a doorway 102, the first estimator may be deactivated and only the second estimator may be used while inside. A similar process may occur in reverse if the user travels back from indoor positioning area 84 to street-level positioning area 82. Because of the accuracy of the probabilistic technique, the likelihood that a correct doorway of the office building is identified for pedestrian navigation purposes (e.g., doorway 102 out of possible doorways 100, 102, 104) may be enhanced. As described previously, in some implementations, the beliefs of the individual active estimators may be sampled based, at least in part, on the calculated probabilities of the active estimators for use in updating a combined belief. This approach may tend to improve accuracy during periods when more than one estimator is active. In this context, estimators for estimating or predicting a navigation state of a mobile device may be combined while the mobile device is in an operating region overlapping indoor positioning area 84 and street-level positioning area 82.

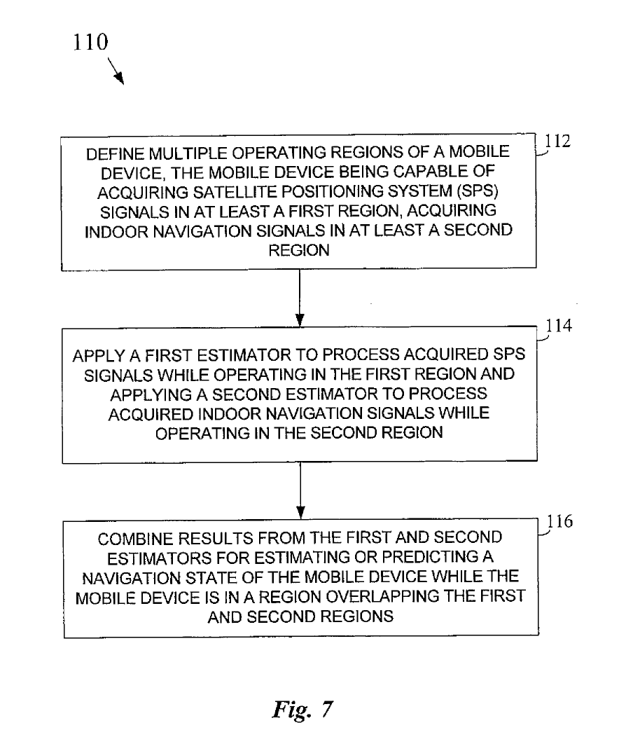

FIG. 7 is a flowchart illustrating an example method 110 for managing a number of estimators associated with a mobile device in accordance with an implementation. Method 110 may be implemented within, for example, mobile device 10 of FIG. 2 (e.g., by estimation manager 24 acting in conjunction with estimators 12, 14, 16, etc.), in other mobile devices, within an external server that is communicating with a mobile device, or at a combination of different locations associated with a mobile device. Multiple operating regions of a mobile device may first be defined, where the mobile device is capable of acquiring satellite positioning system (SPS) signals in at least a first region and acquiring indoor navigation signals in at least a second region (block 112). A first estimator may then be applied to process acquired SPS signals while operating in the first region and a second estimator may be applied to process acquired indoor navigation signals while operating in the second region (block 114). Results from the first and second estimators may then be combined for estimating or predicting a navigation state of the mobile device while the mobile device is in a region overlapping the first and second regions (block 116). In some implementations, the first estimator may comprise application of a Kalman filter to pseudorange measurements obtained from acquisition of SPS signals. In some implementations, the second estimator may comprise application of a particle filter to measured characteristics of acquired indoor navigation signals.

The method 110 may further include continuing application of the first and second estimators for estimating or predicting the navigation state while in the overlapping region, and discontinuing application of the first estimator responsive to a confidence indicator associated with the first estimator. In some implementations, the confidence indicator may be determined based, at least in part, on a computed likelihood that the first estimator is producing reliable solutions. The acquired indoor navigation signals may comprise signals transmitted from a wireless local area network. In certain implementations, the method 110 may further comprise applying the second estimator to measurements obtained from one or more inertial sensors. The combining of the first and second estimators may further comprise combining one or more additional estimators with the first and second estimators for estimating or predicting the navigation state.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

The methodologies described herein can be implemented by various means depending upon the application. For example, these methodologies can be implemented in hardware, firmware, software, or a combination thereof. For hardware implementations, processing may be implemented within, for example, one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof. Herein, the term “control logic” encompasses logic implemented by software, hardware, firmware, or a combination.

For a firmware and/or software implementation, methodologies can be implemented with modules (e.g., procedures, functions, and so on) that perform functions described herein. Any machine readable digital medium tangibly embodying instructions can be used in implementing methodologies described herein. For example, software codes can be stored in a storage medium and executed by a processing unit. Storage can be implemented within a processing unit or external to a processing unit. As used herein, the terms “storage medium,” “storage media,” “storage device,” “digital storage,” or the like refer to any type of long term, short term, volatile, nonvolatile, or other storage structures and are not to be limited to any particular type of memory or number of memories, or type of media upon which data is stored.

If implemented in firmware and/or software, the functions may be stored as one or more instructions or code on a computer readable medium. Examples include computer readable media encoded with a data structure and computer readable media encoded with a computer program. Computer-readable media may take the form of an article of manufacture. Computer-readable media includes physical computer storage media. A computer readable storage medium may be any available digital medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Techniques described herein may be implemented in conjunction with various wireless communication networks such as, for example, a wireless wide area network (WWAN), a wireless local area network (WLAN), a wireless personal area network (WPAN), and so on. The terms “network” and “system” may be used interchangeably. The terms “position” and “location” may be used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a Long Term Evolution (LTE) network, a WiMAX (IEEE 802.16) network, and so on. A CDMA network may implement one or more radio access technologies (RATs) such as, for example, cdma2000, Wideband-CDMA (W-CDMA), and so on. Cdma2000 may include IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma 2000 is described in documents from a consortium named “3rd Generation Partnership Project 2” (3GPP2). 3GPP and 3GPP2 documents are publicly available. A WLAN may be, for example, an IEEE 802.11x network or some other type of network. A WPAN may be, for example, a Bluetooth network, an IEEE 802.15x network, or some other type of network. Techniques disclosed herein may also be implemented in conjunction with any combination of WWAN, WLAN, and/or WPAN.

As used herein, the term “mobile device” refers to a device such as a cellular telephone, smart phone, or other wireless communication device; a personal communication system (PCS) device; a personal navigation device (PND); a Personal Information Manager (PIM); a Personal Digital Assistant (PDA); a laptop computer; a tablet computer; a portable media player; or other suitable mobile or portable device which is capable of receiving wireless communication and/or navigation signals. The term “mobile device” is also intended to include devices which communicate with a personal navigation device (PND), such as by short-range wireless, infra-red, wireline connection, or other connection—regardless of whether satellite signal reception, assistance data reception, and/or position-related processing occurs at the device or at the PND. Also, the term “mobile device” is intended to include all devices, including wireless communication devices, computers, laptops, etc. which are capable of communication with a server, such as via the Internet, Wi-Fi, or other network, and regardless of whether satellite signal reception, assistance data reception, and/or position-related processing occurs at the device, at a server, or at another device associated with the network. Any operable combination of the above are also considered a “mobile device.”

Designation that something is “optimized,” “required,” or other similar designation does not indicate that the current disclosure applies only to systems that are optimized, or systems in which the “required” elements are present (or other limitation due to other designations). These designations refer only to the particular described implementation. Of course, many implementations are possible. The techniques can be used with protocols other than those discussed herein, including protocols that are in development or to be developed.

In the preceding detailed description, numerous specific details have been set forth to provide a thorough understanding of claimed subject matter. However, it will be understood by those skilled in the art that claimed subject matter may be practiced without these specific details. In other instances, methods or structures that would be known by one of ordinary skill have not been described in detail so as not to obscure claimed subject matter.

Some portions of the preceding detailed description have been presented in terms of logic, algorithms, or symbolic representations of operations on binary states stored within a storage medium of a specific apparatus or special purpose computing device or platform. In the context of this particular specification, the term specific apparatus or the like may include a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels.

Unless specifically stated otherwise, as apparent from the following discussion, it is appreciated that throughout this specification discussions utilizing terms such as “processing,” “computing,” “calculating,” “determining,” “establishing,” “obtaining,” “identifying,” “selecting,” “generating,” “estimating,” “initializing,” or the like may refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general purpose computer once it is programmed to perform particular functions pursuant to instructions from program software.

A computer-readable storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

A satellite positioning system (SPS) typically includes a system of transmitters positioned to enable entities to determine their location on or above the Earth based, at least in part, on signals received from the transmitters. Such a transmitter typically transmits a signal marked with a repeating pseudo-random noise (PN) code of a set number of chips and may be located on ground based control stations, user equipment and/or space vehicles. In a particular example, such transmitters may be located on Earth orbiting satellite vehicles (SVs). For example, a SV in a constellation of Global Navigation Satellite System (GNSS) such as Global Positioning System (GPS), Galileo, Glonass or Compass may transmit a signal marked with a PN code that is distinguishable from PN codes transmitted by other SVs in the constellation (e.g., using different PN codes for each satellite as in GPS or using the same code on different frequencies as in Glonass). In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to particular disclosed examples, but that such claimed subject matter may also include all aspects falling within the scope of appended claims, and equivalents thereof.

What is claimed is:

1. A machine implemented method comprising:
calculating probabilities of multiple position estimators associated with a mobile device;
sampling beliefs of said multiple position estimators based, at least in part, on said probabilities to generate first samples; and
updating a combined belief for said multiple positioning estimators based, at least in part, on said first samples.

2. The method of claim 1, wherein:
said calculating probabilities of said multiple position estimators associated with said mobile device includes calculating a probability that a first estimator's belief and measurement model corroborate observed measurements.

3. The method of claim 1, further comprising:
propagating said beliefs of said multiple position estimators forward in time to compensate for elapsed times between measurements before calculating said probabilities.

4. The method of claim 3, further comprising:
sampling said beliefs of said multiple position estimators after said propagating to generate second samples; and
determining whether to activate a new estimator based, at least in part, on said second samples.

5. The method of claim 1, further comprising:
determining whether to deactivate a first estimator of said multiple position estimators based, at least in part, on a corresponding one of said probabilities.

6. The method of claim 5, wherein:
said determining whether to deactivate said first estimator includes determining to deactivate said first estimator if said corresponding one of said probabilities is below a threshold value.

7. The method of claim 1, wherein:
calculating probabilities of said multiple position estimators further includes calculating probabilities that sum to approximately one.

8. The method of claim 1, wherein:
said calculating probabilities of said multiple position estimators includes using an expression:
$$p ( {e}_{r} \vert {y}_{k} ) = \frac{p ( {y}_{k} \vert {e}_{r} ) p ( {e}_{r} )}{{\sum }_{∀ {e}_{r}}^{ } p ( {y}_{k} \vert {e}_{r} ) p ( {e}_{r} )}$$
where p(eᵣ|yₖ) is a probability of estimator eᵣ given measurements yₖ, p(yₖ|eᵣ) is a likelihood of measurement yₖ given that estimator eᵣ is being used, p(eᵣ) is a belief of estimator eᵣ given previous measurements of probability of estimator eᵣ, and Σ_{∀e}_{ᵣ}p(yₖ|eᵣ)p(eᵣ) is a sum of a product of p(yₖ|eᵣ) and p(eᵣ) over said multiple position estimators.

9. The method of claim 8, wherein:
said calculating probabilities of said multiple position estimators includes using an expression:
p(yₖ|eᵣ)=∫p(yₖ|xₖ, eᵣ)p(xₖ)dxₖ
where p(yₖ|xₖ, eᵣ) is a measurement model of estimator eᵣ and p(xₖ) is a belief of estimator eᵣ.

10. The method of claim 1, wherein at least one of said position estimators is based, at least in part, on a Kalman filter.

11. The method of claim 1, wherein at least one of said position estimators is based, at least in part, on a particle filter.

12. An apparatus comprising:
one or more sensors to obtain measurements; and
a processor to:
initialize a combined belief for active estimators of a plurality of position estimators based, at least in part, on said measurements;
calculate probabilities of said active estimators;
sample beliefs of said active estimators based, at least in part, on said probabilities to generate samples; and
update said combined belief for said active estimators based, at least in part, on said first samples.

13. The apparatus of claim 12, wherein:
said probabilities of said active estimators include probabilities that beliefs and measurement models of individual estimators corroborate observed measurements.

14. The apparatus of claim 12, wherein the processor is further to propagate said active estimators forward in time to compensate for elapsed times between measurements before said probabilities are calculated.

15. The apparatus of claim 14, wherein the processor is further to:
sample said beliefs of said active estimators after said beliefs have been propagated forward in time to generate second samples; and
determine whether to activate an inactive estimator in said plurality of position estimators based, at least in part, on said second samples.

16. The apparatus of claim 12, wherein the processor is further to determine whether to deactivate a first active estimator in said plurality of position estimators based, at least in part, on a corresponding calculated probability.

17. The apparatus of claim 12, wherein:
said probabilities of said active estimators calculated by said estimation manager sum to approximately one.

18. The apparatus of claim 12, wherein the processor is further to use the following expression to calculate said probabilities of said active estimators:
$$p ( {e}_{r} \vert {y}_{k} ) = \frac{p ( {y}_{k} \vert {e}_{r} ) p ( {e}_{r} )}{{\sum }_{∀ {e}_{r}}^{ } p ( {y}_{k} \vert {e}_{r} ) p ( {e}_{r} )}$$
where p(eᵣ|yₖ) is a probability of estimator eᵣ given measurements yₖ, p(yₖ|eᵣ) is a likelihood of measurement yₖ given that estimator eᵣ is being used, p(eᵣ) is a belief of estimator eᵣ given previous measurements of probability of estimator eᵣ, and Σ_{∀e}_{ᵣ}p(yₖ|eᵣ)p(eᵣ) is a sum of a product of p(yₖ|eᵣ) and p(eᵣ) over said multiple position estimators.

19. The apparatus of claim 18, wherein:
said estimation manager is further to use the following expression to calculate said probabilities of said active estimators:
p(yₖ|eᵣ)=∫p(yₖ|xₖ, eᵣ)p(xₖ)dxₖ
where p(yₖ|xₖ, eᵣ) is a measurement model of estimator eᵣ and p(xₖ) is a belief of estimator eᵣ.

20. An article comprising:
a non-transitory storage medium comprising machine-readable instructions stored thereon which are executable by a special purpose computing apparatus to:
calculate probabilities of multiple position estimators associated with a mobile device;
sample beliefs of said multiple position estimators based, at least in part, on said probabilities to generate first samples; and
update a combined belief for said multiple positioning estimators based, at least in part, on said first samples.

21. The article of claim 20, wherein said instructions are further executable by said special purpose computing apparatus to:
propagate said beliefs of said multiple position estimators forward in time to compensate for elapsed times between measurements before calculating said probabilities.

22. The article of claim 21, wherein said instructions are further executable by said special purpose computing apparatus to:
sample said beliefs of said multiple position estimators after said propagating to generate second samples; and
determine whether to activate a new estimator based, at least in part, on said second samples.

23. The article of claim 20, wherein said instructions are further executable by said special purpose computing apparatus to:
determine whether to deactivate a first estimator of said multiple position estimators based, at least in part, on a corresponding one of said probabilities.

24. The article of claim 23, wherein said instructions are further executable by said special purpose computing apparatus to:
determine whether to deactivate said first estimator by determining to deactivate said first estimator if said corresponding one of said probabilities is below a threshold value.

25. An apparatus comprising:
means for calculating probabilities of multiple position estimators associated with a mobile device;
means for sampling beliefs of said multiple position estimators based, at least in part, on said probabilities to generate first samples; and
means for updating a combined belief for said multiple positioning estimators based, at least in part, on said first samples.

26. A method comprising, at a mobile device:
defining multiple operating regions of said mobile device, said mobile device being capable of acquiring satellite positioning system (SPS) signals in at least a first region, acquiring indoor navigation signals in at least a second region;
applying a first estimator to process acquired SPS signals while operating in said first region and applying a second estimator to process acquired indoor navigation signals while operating in said second region; and
combining results from said first and second estimators for estimating or predicting a navigation state of said mobile device while said mobile device is in a region overlapping said first and second regions.

27. The method of claim 26, wherein said first estimator comprises application of a Kalman filter to pseudorange measurements obtained from acquisition of SPS signals.

28. The method of claim 27, wherein said second estimator comprises application of a particle filter to measured characteristics of acquired indoor navigation signals.

29. The method of claim 26, and further comprising:
continuing application of said first and second estimators for estimating or predicting said navigation state while in said overlapping region; and
discontinuing application of said first estimator responsive to a confidence indicator associated with said first estimator.

30. The method of claim 29, wherein said confidence indicator is determined based, at least in part, on a computed likelihood that said first estimator is producing reliable solutions.

31. The method of claim 26, wherein said acquired indoor navigation signals comprise signals transmitted from a wireless local area network.

32. The method of claim 26, and further comprising applying said second estimator to measurements obtained from one or more inertial sensors.

33. The method of claim 26, wherein said combining results further comprises combining results from one or more additional estimators with said results from said first and second estimators for estimating or predicting the navigation state.

34. An apparatus comprising:
a receiver to acquire satellite positioning system (SPS) signals and indoor navigation signals; and
a processor to:
define multiple operating regions of a mobile device including a first region where said mobile device is capable of acquiring satellite positioning system (SPS) and a second region where said mobile device is capable of acquiring indoor navigation signals;
apply a first estimator to process said acquired SPS signals while said mobile device is operating in said first region and apply a second estimator to process said acquired indoor navigation signals while said mobile device is operating in said second region; and
combine results from said first and second estimators for estimating or predicting a navigation state of said mobile device while said mobile device is in a region overlapping said first and second regions.

35. The apparatus of claim 34, and further comprising one or more inertial sensors, and wherein said processor is further to:
apply said second estimator to measurements obtained from said one or more inertial sensors.

36. An article comprising:
a non-transitory storage medium comprising machine-readable instructions stored thereon which are executable by a special purpose computing apparatus to:
define multiple operating regions of a mobile device including a first region where said mobile device is capable of acquiring satellite positioning system (SPS) and a second region where said mobile device is capable of acquiring indoor navigation signals;
apply a first estimator to process said acquired SPS signals while said mobile device is operating in said first region and apply a second estimator to process said acquired indoor navigation signals while said mobile device is operating in said second region; and
combine results from said first and second estimators for estimating or predicting a navigation state of said mobile device while said mobile device is in a region overlapping said first and second regions.

37. An apparatus comprising:
means for defining multiple operating regions of said mobile device, said mobile device being capable of acquiring satellite positioning system (SPS) signals in at least a first region, acquiring indoor navigation signals in at least a second region;
means for applying a first estimator to process acquired SPS signals while operating in said first region and applying a second estimator to process acquired indoor navigation signals while operating in said second region; and
means for combining results from said first and second estimators for estimating or predicting a navigation state of said mobile device while said mobile device is in a region overlapping said first and second regions.
